(19) United States
(12) Patent Application Publication
(10) Pub. No.: US 2011/0245965 A1
(43) Pub. Date: Oct. 6, 2011

(54) Method and Apparatus for Procurement and Resale of New and Used Media

(76) Inventor: Patrick A. Farrell, (US)

(21) Appl. No.: 12/752,040

(22) Filed: Mar. 31, 2010

(51) Int. Cl. G06Q 30/00; G06F 17/00; G06F 17/30; G06F 15/16

(52) U.S. Cl. 700/232; 700/231; 707/769; 709/201; 707/E17.014; 705/26.1

(57) ABSTRACT

A new business method for acquiring and reselling new and used media or other similar items by creating a collection of network-accessible databases and computer scripts stored on a secure server and by connecting this server to machines that are distributed across a market geographically and function as vending and “reverse vending” points, and by further allowing access to other business entities such as owners and operators of the machines, and other business entities who are customarily involved in the wholesale or resale of the items purchased or sold throughout the machines, or other methods of procurement, and to laypersons who have presented items for sale to these reverse vending machines or other methods of procurement. When all of said entities and machines become connected and fully operational within this business system, new and used media or other suitable items can be randomly purchased from diverse segments of an existing marketplace, made available to wholesalers and resellers and other individual buyers, so as to facilitate and expedite the process of uniting buyers and sellers of items that may be procured and resold through this business system, and to achieve these results in a manner that is asynchronous and convenient for each party or entity participating in this business system.

### FIELD OF THE INVENTION

The present invention is intended to be used within an existing or newly created marketplace that is concerned with the random purchasing and reselling of new and used media items or other similarly purchased and sold items such as consumer electronics or common consumer goods that may have recognizable value in a broadly presented resale marketplace.

### BACKGROUND OF THE INVENTION

It is common for media items, (such as books, music CDs, movie DVDs and electronic games) to be sold on ecommerce marketplaces that specialize in the sale of such items, and also common for these marketplaces to make their ecommerce systems available to other merchants who offer similar items for sale in such a manner as to make use of the database of items-for-sale already created and used by the owner or operator of the existing ecommerce systems. An example of such ecommerce is the various websites that offer new and used books for sale to any individuals who choose to patronize such systems by means of a common web browser.

These specialized websites have added functionality to their ecommerce system that makes it easy for any person or entity wishing to sell similar items to access the ecommerce system, create an identification account, and associate their own inventory with the newly created account for the purpose of selling their own inventory through the more commonly recognizable and more frequently patronized ecommerce website.

This practice has become very common with the general community at large—so common as to comprise a considerably large community of professional resellers that operate individually within specific geographic markets for the purpose of procurement, and then sell their inventory, in some cases exclusively, as a large online aggregate of autonomous businesses. The selling side of their business is guaranteed success by the sheer volume of items presented for sale into these singular but widely recognized and frequently patronized ecommerce websites. However, it is common for such small business entities to suffer from a lack of procurement opportunities, or to incur such large expenses in the procurement process as to threaten their sustainability.

Also, this ad hoc aggregation of specialized business entities are laterally disconnected except by their shared and common use of singular ecommerce websites which offer no additional services outside their offering of storefront opportunity for the placement of items for sale, and in some cases by common use of web-based chat rooms. This aggregation by the shared practice of online selling creates no opportunity for the lateral exchange of items-for-sale beyond those available to the general community at large, such as the general buying and selling opportunity created by the commonly used ecommerce website.

For the individual layperson who does not act as a business entity but does have new or used media items, or other similar items, and wishes to sell such items to an interested buyer, there is no convenient method of doing so that would create fast and reliable results without going through extraordinary efforts to do so.

### OBJECTS OF THE METHOD AND APPARATUS

The first object of the system is a collection point that would be accessible to all individual laypersons wishing to use the system. This object would be a machine designed as an assembly of electronic and mechanical items that would function together so as to allow random media or similar items to be presented and then identified by way of a computerized control system performing a database lookup, and then to be priced by the database and control system. This part of the system would then present the determined pricing to the layperson wishing to sell the presented item in such a way as to allow this layperson an opportunity to accept or reject the stated purchase price. If accepted by the layperson, this machine would then have the ability to record the presence of the item by means of bar code recognition, or RFID recognition, or by photographing the object, or by other similar means of electronically recording it's presence in the machine. The machine would also have the ability to move the newly purchased item into a storage location for later retrieval. The actual storage area could be a central repository, or a movable canister or movable resting surface, or other suitable physical storage device.

This machine would further allow removal of the item by the machine's owner or other designated individual in such a way as to preserve the identity of the purchased and stored item for further processing of the purchased item in the electronic system.

And this machine would allow a layperson to identify a bank or credit card account, or other type of account such as a Paypal account, for the purpose of depositing funds as consideration from the sale of presented media items, or other items, into that account. This identification process could be accomplished by presenting a card with a magnetically stored data record, or RFID chip with similar data, or by manually typing the data using a keypad or touch-screen.

The second object of the system is a set of computer programs that together comprise a local computerized control system that is stored in the local machine for the purpose of reading inputted values from such devices as electronic or magnetic card readers or barcode scanners or RFID scanners, and control the movement of mechanical components that provide all necessary functional requirements of the local machine, described as the first object of the invention, and to record events and data on a local storage medium, and to communicate through a networked connection to a server for the purpose of exchanging data relating to the transactions necessary for the purchase, collection and resale of the items purchased.

The third object of the system is a method employed by the local computerized control system that allows the local control system to determine the presence and integrity of locally stored data files and locally stored computer programs, including itself, and a method for updating such data files and programs, and for restarting itself according to such updates, and further to render itself inoperable if a recognized corruption has occurred that would prevent itself from repair or acquiring an updated version, or prevent normal operation without such an update when such an update is not available.

The fourth object of the system is a set of computerized programs that together comprise a computer control system that is placed onto a server for the purpose of routing and storing the data that records and enables transactions necessary for the entire invention to work. These programs include MCV modules for accepting http requests or other requests delivered in a similar messaging protocol, and a data file storage structure, and a module for routing messages, and a module for creating and verifying the delivery of ACH transaction authorizations.

The fifth object required for the system is a set of encryption methods that allow data to be stored, transferred, and decrypted in such a manner as to provide adequate security to all parties involved in said transactions.

The sixth object of the invention is a method for allowing wholesale organizations to provide a specialized pricing database to be stored onto the server so that individual machine owners can access that database for ordinary purchasing, and an items-purchased database that pushes purchased-items data back to the wholesale organization.

This specialized layer of the system further involves the creation of data within procurement transactions that facilitate the sale, shipping and payment process for moving items purchased by the machine back to the wholesale organization in a manner that is timely, efficient and convenient for all parties.

The seventh object of the invention is a machine that can vend media or other such items back to the public. The design of this machine is such that it can be placed adjacent to the machine described in the first object, so that the control system for the procurement machine can be used to control the operation of the vending machine. This vending machine can, in another instance, contain its own computerized control system for the purpose of controlling all machine functions and transactional data, and for exchanging this data with the networked server(s) as described in the fourth object of this invention. In another instance this machine would be designed to be manufactured into the machine of the first object of this invention, so that a layperson could sell randomly presented media items or other similar items, and purchase similar items, or other items, from one single point of operation.

The eighth object of this invention is a system for identifying existing or recently procured inventory that exists locally within a geographic market and making this information available to the general public and machine owners or operators within or adjacent to that geographic market. A layperson would then be able to predetermine an item for purchase, and if so desired complete a purchase of the selected item by use of a common web-browser or other means. Once this transaction is completed, the owner of the inventory would be notified of the item being purchased and the desired point of pickup designated by the layperson making the purchase. If the desired pickup location is not specifically a location where a vending machine owned by the seller of the item is located, but rather is a location of a vending machine owned by anther operator or business entity, then the seller of the item will in a timely manner deliver the sold inventory to that location by use of the machine described as the first object of this invention, or other predetermined and suitable method, so that that the owner of the vending machine at the desired location can make it immediately available to the layperson making the purchase. The computer control system described as the fourth object of this invention will notify all parties of the incremental steps required to move the item from its original inventory to the final point of dispensing to the layperson, and of the completion of the this process.

In such an instance as described, where the sold item is withdrawn from the inventory of one machine owner, and finally dispensed to the purchasing layperson by a machine owned and operated by a third party to the transaction, the third party providing the dispensing service can receive consideration in monetary form, or in the form of transaction points, where such a point system is made available to participating machine owners an other participants, and is facilitated by the computerized control system described as the fourth object of this invention. Such a point system would exist as a series of credits and debits, which, over time would create and maintain balances plus or minus, so as to create a system within the larger system, allowing a fair and continued exchange of such services in the interest of the participating machine owners and the general public.

The ninth object of this invention is an enhancement of all of the above mentioned objects, so as to allow the general purchase, sale, and exchange of goods across a contiguous network of geographic markets. In this enhanced version of the system, a network of machines which can both receive and store goods, and also dispense these same goods, are located strategically, each positioned within a geographic market at locations which are convenient and well traveled. A networked control system such as object four will maintain and facilitate the deposit, sale, or inventory placement in all machines so as to allow laypersons and machine owners who own inventory, and non-machine owners who also own inventory, to place items into the system in a geographic location convenient to that party. This same system will similarly facilitate and maintain a system that will allow for the withdrawal of these and other goods as sold, for such consideration as agreed upon and rendered, in a manner and location that is convenient for the party making the purchase of the goods.

This object, behaving as a system within a larger system, can allow for consideration to be granted and received in monetary form, or as points earned and spent within the system as described here and similarly described in object eight. This enhanced embodiment of the machines described within objects one through three and object seven differs slightly in that deposits and withdrawals are made from a single point without the intervention of that machine's owner or operator. Rather, a system of authorization codes are used to give individuals other than a machine's owner the ability to remove a desired item that was sold as a transaction within this enhanced business system. Items may then be transported across a geographic market by either the seller or the buyer of the good(s), or a third party acting as a courier. Similarly, items may be re-deposited into a second machine for resale or even for further transportation across a geographic market.

### BRIEF DESCRIPTION OF THE DRAWINGS

FIG. 1 is a diagrammatic perspective view of a reverse vending machine of the method and apparatus for buying randomly presented media items within the system of the present invention

FIG. 2 is a system block diagram of the PC control system used by the reverse vending apparatus of the present invention.

FIG. 3 is a diagrammatic perspective of an intermediate storage system as used by the reverse vending apparatus of the system of the present invention

FIG. 4 is a flowchart showing the basic method of operation for a reverse vending apparatus employed by the system that is the present invention.

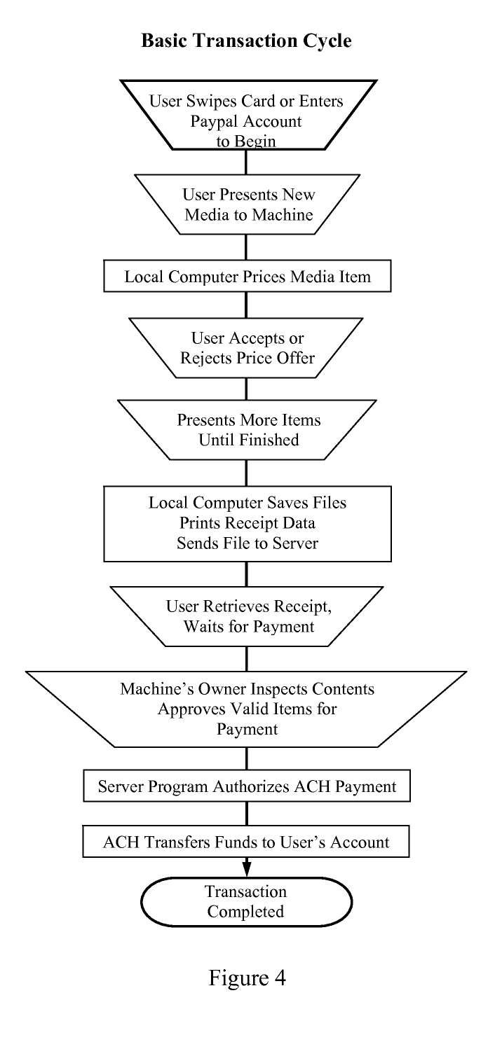

FIG. 5 is a flowchart that details the layperson's interactions with a reverse vending apparatus as employed by the system that is the present invention.

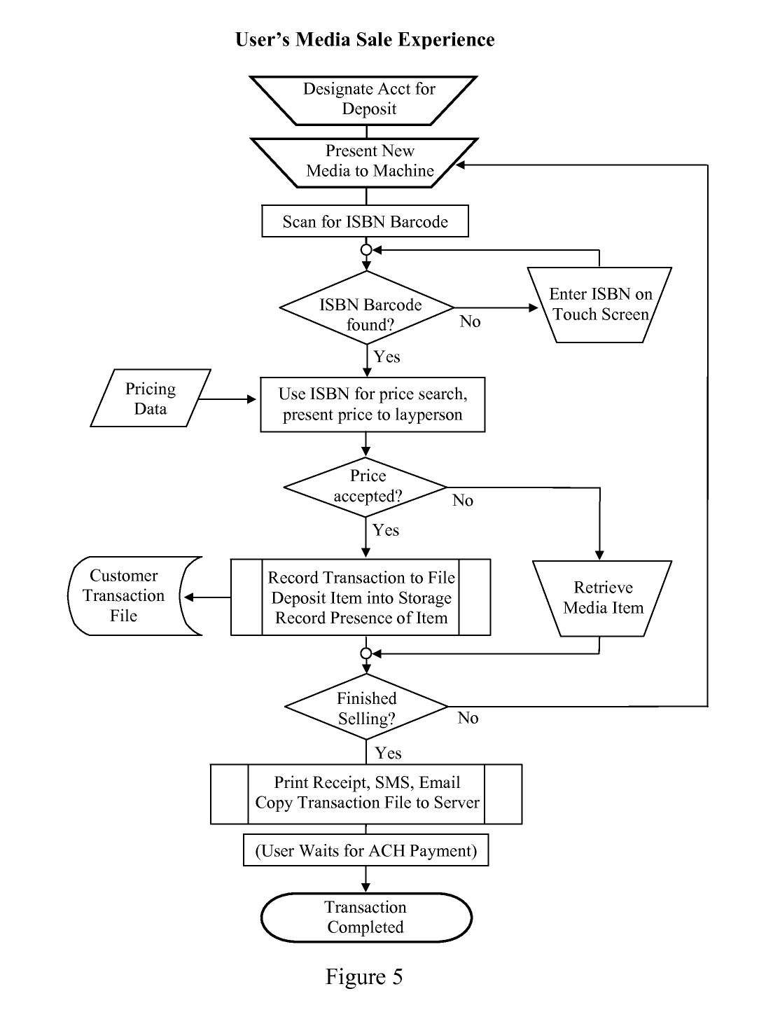

FIG. 6 is a flowchart that details the functions and logic for the method and apparatus that is a reverse vending apparatus as employed by the system that is the present invention.

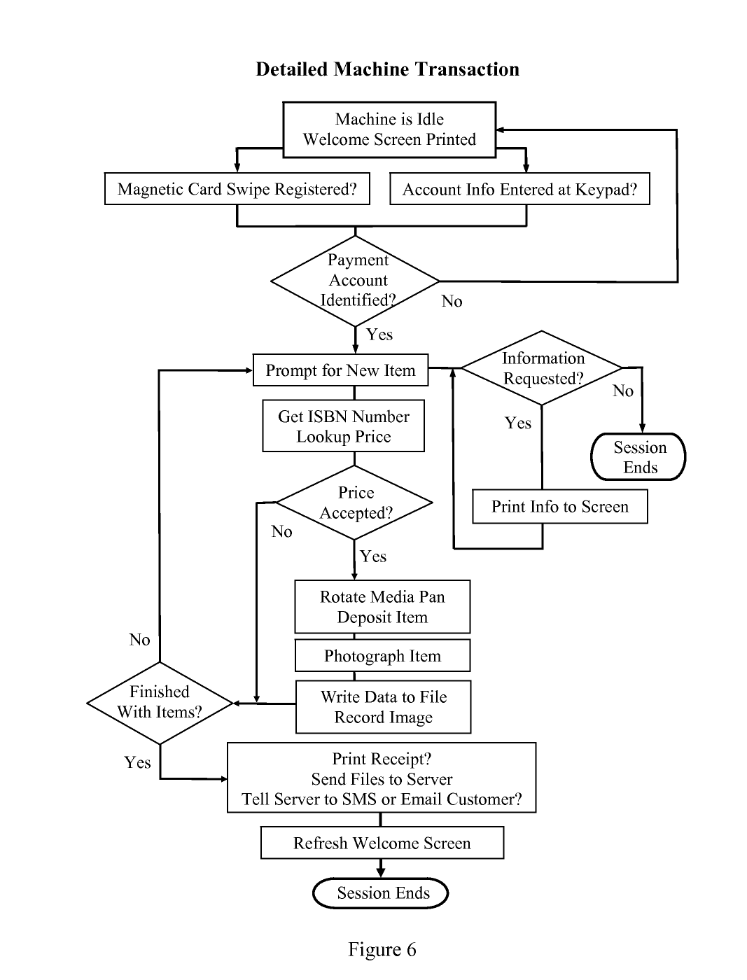

FIG. 7 is a diagrammatic perspective view of a media vending machine of the method and apparatus for selling randomly chosen media items within the system of the present invention.

FIG. 8 is a diagrammatic perspective view of a Large Multi-Use model of the method and apparatus for buying or selling randomly chosen media items within the system of the present invention.

FIG. 9 is a system block diagram of the entire networked control system that includes the method and apparatus of the present invention.

FIG. 10 is a diagrammatic perspective view of a geographic deployment of the method and apparatus for buying or selling randomly chosen media items within the system of the present invention.

FIG. 11 is a diagrammatic perspective view of a geographic deployment and demonstrated usage of the method and apparatus for buying or selling randomly chosen media items within the system of the present invention.

FIG. 12 is also a diagrammatic perspective view of a geographic deployment and demonstrated usage of the method and apparatus for buying or selling randomly chosen media items within the system of the present invention.

FIG. 13 is a diagrammatic perspective view of a point system of the method and apparatus for buying or selling randomly chosen media items within the system of the present invention.

FIG. 14 is a diagrammatic perspective view a large deployment of users and non-users of the point system of the method and apparatus for buying, selling, or transporting randomly chosen media items within the system of the present invention.

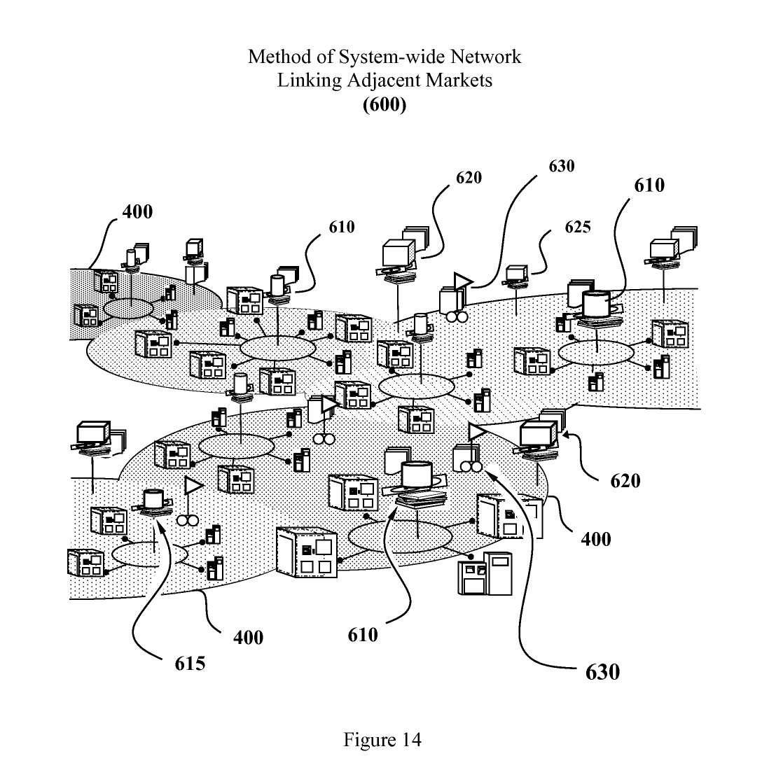

### SUMMARY OF THE INVENTION

The present invention relates to apparatus and methods for extending the business practice of buying new and used media such as books, CDs, DVDs or electronic games or other similar items to laypersons desiring to sell such items, in a manner which is wholly automated and asynchronous. The apparatus comprises a storage system, a personal or embedded computer, and electronic items for reading magnetic cards or barcodes or RFID chips, one or more electronic cameras, and a means of connecting to a wide area network such as the internet.

The method allows for a layperson to present random media items of varying types, values, and sizes to a single point of purchasing that is automated in such a was as to make purchasing offers based on the calculated value of each item presented, and an apparatus for accepting and storing the newly purchased item. It also allows for the recording of specific data relating to a purchase transaction and for the transmission of such data across a wide area network for the purpose of placing data onto a server and for the purpose of sending such data directly to personal electronic devices of owners or managers of the purchasing apparatus.

In a one such example the apparatus of the invention could also embody additional functionality for the purpose of vending or dispensing similar items within the geographical market.

The method further includes the computer programs and data structures placed onto a networked server. These programs and data allow the system to consolidate an aggregation of independent business owners with a combined purchasing volume that would represent a wholesale model. It further allows each of these owners to access a collection of individual machines that are located in separate or proximate geographical markets.

In its preferred embodiment, the method and apparatus of the invention would allow for random purchases, sale, and distribution of various items across geographic and proximate markets by strategically locating the apparatus at various placements within the markets A-C and connecting all machine operators, laypersons, and related users of the system together by use of networked servers and wide area networks. This would also include a point system to allow transactions to occur as credits and debits, without the transfer of money as consideration, when such non-monetary consideration might facilitate a transaction that would otherwise be inhibited.

### DETAILED DESCRIPTION OF THE PREFERRED EMBODIMENT

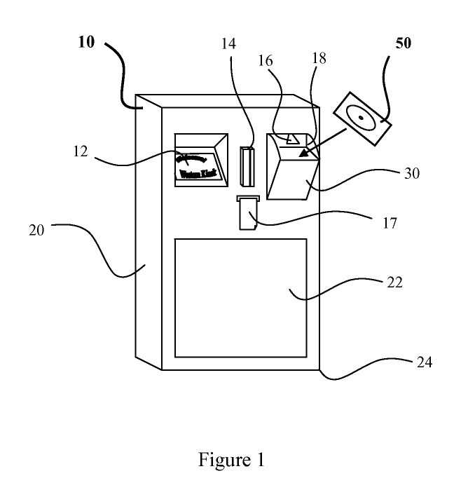

FIG. 1 shows a specialized reverse-vending machine 10. This machine which is an example of the preferred embodiment of the invention consists of four primary parts. These parts may be described as an outer shell 24, an electronic assembly, a storage system 20, and an intermediate storage system 18.

The first part is the outer shell 24 of sheet metal or other structurally sound material which supports the remaining three parts. This part contains access panels 22 for the electronics, the storage areas 20 and other maintenance areas. In examples where the design is a small model, it may posses adjustable feet, and in larger models that are meant to be permanent installations it may be fitted with a canopy or protective covering and exterior lighting.

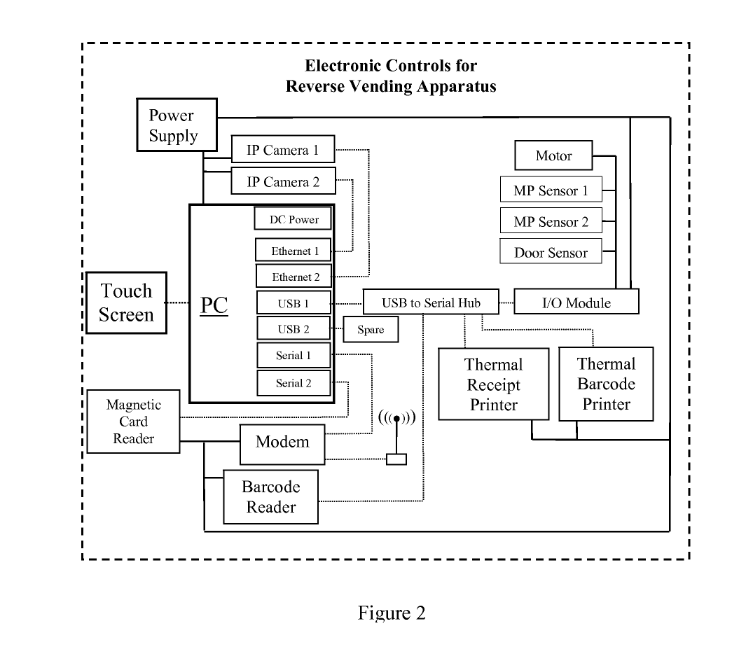

The second part is an assembly FIG. 2 including but not limited to a personal or embedded computer 12, a computer touch screen 12, or an alphanumeric keypad and a computer display screen 12, a receipt printer 17, and a barcode scanner 18. Another included electronic device is a magnetic or RFID card reader 14 which can retrieve data from a common credit card as used in most commercial establishments. Other electronic components would be concealed within the shell 24 of the apparatus, such as a power supply and voltage converters, wiring and terminating connectors, surge suppression or short circuit protection and a modem or cellular modem. Some of the electronic components would be assembled onto the other parts, such as the internal storage area or intermediate storage area. And some components would assemble directly to the shell 24 itself. In one example of this preferred embodiment of the invention the shell would protect and conceal an electronic surveillance camera for security purposes.

The third part of the machine is a storage system 20 for the items that have been recently purchased or donated. This part of the design includes one or more storage canisters or platforms that would allow for automated delivery of the item into each canister or platform. In one example of the invention the canisters or platforms are rotated into an alignment position to allow the deposit or removal of the stored item. The rotating storage canisters and platforms may be guided and supported by well known bearing rails or by cables or by well known reinforced timing belts. An external sensor may be used to determine the alignment position for deposit and also for item removal. The deposit and removal areas may be coincidental or may be two separate locations within the machine.

In one example of the usage of a plurality of storage areas each storage area may be labeled with a barcode label, RFID chip, or other passive digital device such as a series of metallic targets that when identified as a series of objects which are present or missing represent a unique digital value such as a byte of data.

In another example of the preferred embodiment of the invention, where such a machine is quite large and comprises a plurality or more of storage areas, the storage canisters or platforms may be permanently fixed, and the motors, sensors, rails and cables or timing belts may be used to move a placement and retrieval mechanism. Such an example of the storage design would be related to a well known Automated Storage and Retrieval System, and would be designed into the surrounding embodiment of the invention as described herein.

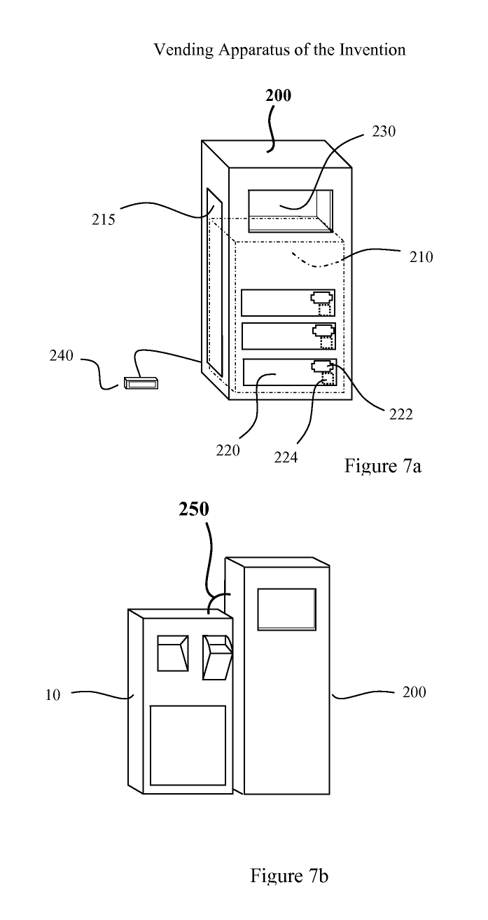

In yet another example (FIGS. 7a & 8) of the preferred embodiment of the invention, where such a machine is quite large 260 and comprises a plurality or more of storage areas 220, some of the storage areas may be accessed directly by users of the system by means of an electromechanical latch 222 and sensor 224, where laypersons or other users of the system may enter a pass-code at the computer touch screen 12 to gain access to specific storage compartments as predetermined by the logic of the method and system of the invention.

The fourth part of the preferred embodiment of the invention is related to a temporary storage 18 area where an item that is contemplated for purchase 50 and storage 20 can be placed by the layperson using the embodiment of the invention. The temporary storage area 18 would be positioned within the machine so as to allow a user of the machine to place an object into the temporary storage area 18 and to further allow the machine to use such an electronic device as described within the second part of the design, such as a barcode scanner 16 or an RFID reader to attempt a determination of a recognizable feature of the item such as an ISBN number for a published media item 50, 51 or an SKU number of a similar item. This intermediate storage area 18 further improves the design by allowing the layperson placing the item 50, 51 therein to then remove the item without the benefit of a sale of the item.

The preferred embodiment is further improved by the relation of this intermediate storage area 18 to the permanent storage depositing area 20, or the mechanism which moves the item from this position to its final storage canister or resting platform.

In one such an example of the preferred embodiment, the intermediate storage area 18 is also the mechanism that transfers the item into the storage canister after approval by the layperson.

In any example of the invention, the intermediate storage area 18 also serves a separation medium to keep the layperson from attempting an unsafe or problematic motion such as removal of the item while the mechanism of the apparatus is also moving the item.

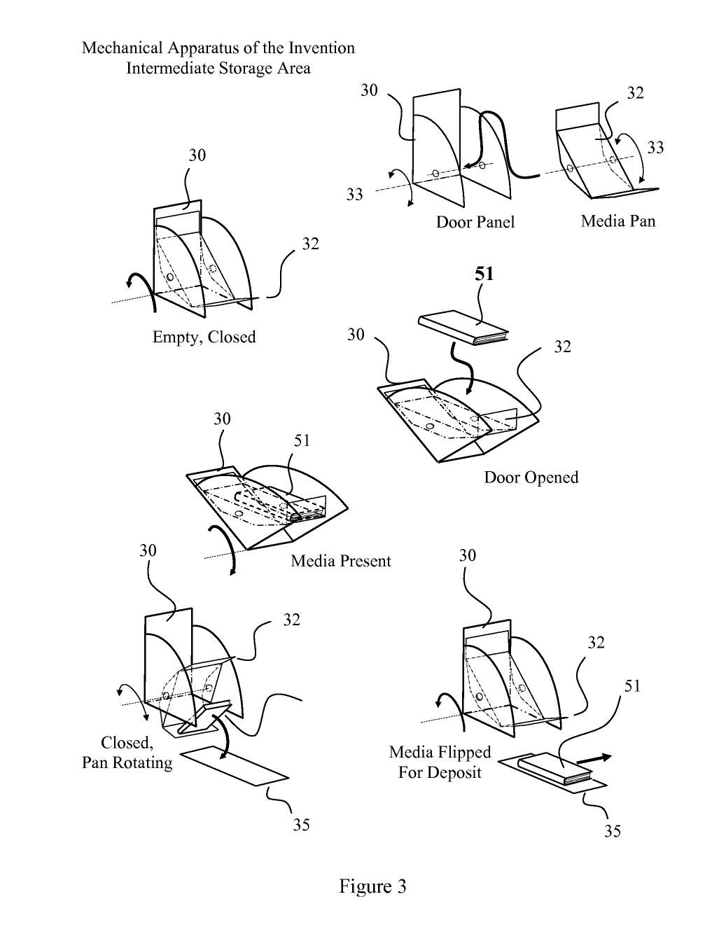

In one example of the preferred embodiment, as shown in FIG. 3, the intermediate storage area is designed as a rotating media pan 32 that is captive within the media access door 30 by means of a shaft, so that the media pan can rotate about a horizontal axis 33 within its captive position. In a further contemplation of the design a gear-motor and sensors would be attached to the media unit, with a second gear attached to the media pan. The gear-motor would cause the media pan to rotate about its axis 33 so that an item 51 deposited in the pan would be flipped upside down onto a second intermediate platform 35 which allows a photographic record of the deposited item to made, and arrests the fall of the deposited item.

A further enhancement of the design allows for flexible storage compartments that can collapse or expand to match the thickness of randomly presented items. This storage design can also be used for items to be vended to individuals. By combining the storage of inbound items with the storage of inventory for sale, a single system can be created that both purchases and vends random types of media or similar items. In one example of such a design the vending apparatus 200 has its own personal or embedded computer 12 and touch screen or keypad and display, and functions as an autonomous system.

In another example of such a design, seen in FIG. 7b, the vending apparatus 200 sits next to another unit 200, such as an autonomous vending apparatus, or a purchasing apparatus 10, and uses the computer control system and interface features of said apparatus 200, 10 for machine control.

In another example of this design, the vending apparatus 200 is designed into the structure of an autonomous unit 10 allowing a plurality or more of storage and vending systems to exist within a single unit 250.

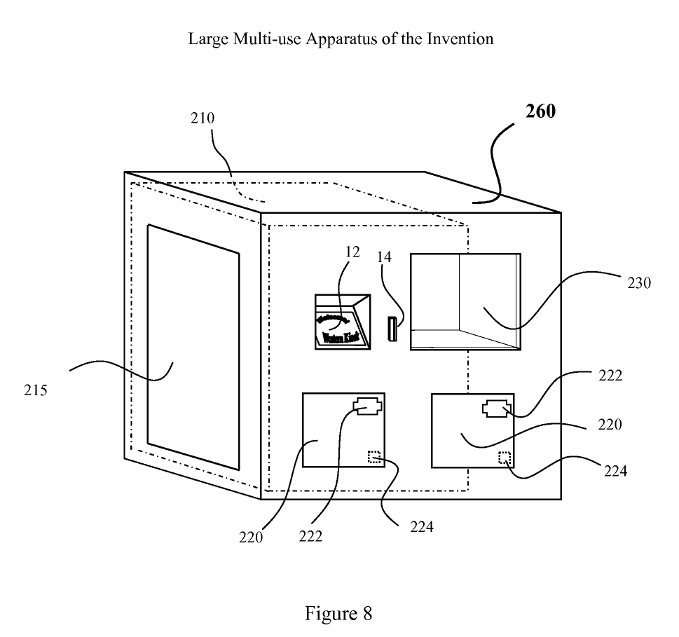

In another example of such a design, as in shown in FIG. 8, the vending apparatus 200 is designed into the structure of a media purchasing system 10, so that the entire apparatus 260 comprises the ability to purchase randomly presented media items 50, or vend randomly selected media items from the same single apparatus.

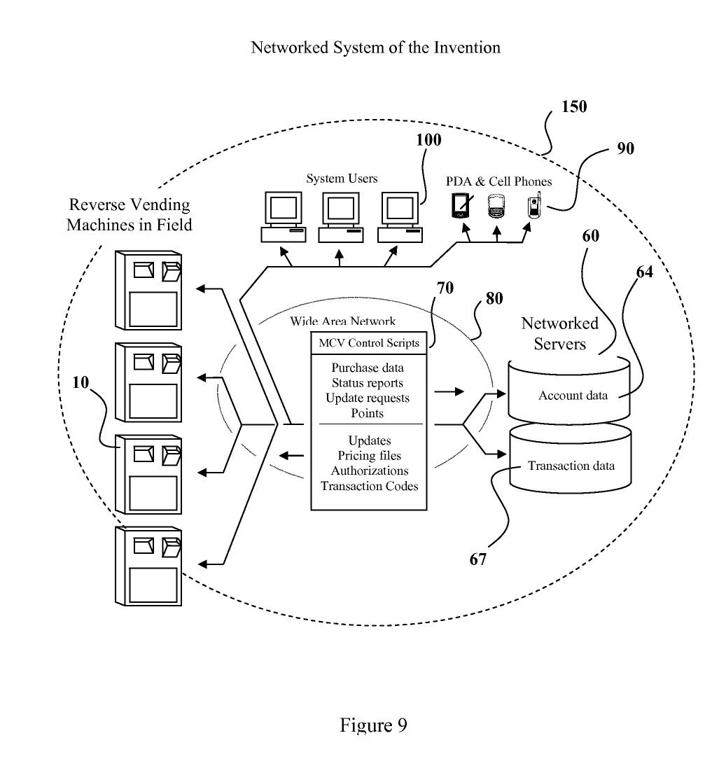

FIG. 9 A contemplation of the preferred embodiment of the invention as described herein requires the use of well known wide area networks 80, and of well known servers 60 connected to such wide area networks 80, and the use of data structures 64 67 placed on the server 60 and of computer scripts 70 used to store and retrieve the data 64 67 of said data structures, and use preconfigured logic 70 to make decisions about how and when such data 64 67 is stored or retrieved. Such an implementation of well known servers would also make use of authorization procedures that are common when allowing a multitude of users 100 to connect to such a networked system 150 for the purpose of storing, retrieving or editing of said data 64.

This contemplation of the preferred embodiment of the invention would allow each apparatus of the invention 10 250 260 strategically placed in physical locations for buying and vending of various items 50 51 to have a unique ID and to further have a means of connecting to the networked system 150 for the purpose of storing and retrieving data 64 67. This data would include records of transactions 67 that occur at the apparatus 10 itself, such as the recent purchase of items 50 51 from a layperson.

In addition to a unique ID for the purpose of access to the secure server 60 on the network 80, a configuration file 64 would be associated with each instance of said apparatus 10 250 260 of the invention. These files that are unique to each and every instance of the apparatus 10 250 260 would include important data 64 about the apparatus itself, such as a unique ID number for security as mentioned herein, and also data 64 that would indicate personal preferences of the owner of the apparatus. One example of such preferences would be the unique ID number of the owner of the apparatus, and another example would be how and when information regarding updated transactions or current operating condition of the apparatus, or current status of the apparatus should be transmitted back out of the networked system 150 for the purpose of notifying the owner of the apparatus, or a designated agent or employee of the owner, when such significant events have occurred.

Similarly, each individual or business entity owning an apparatus 10 250 260, or a plurality or more of said apparatus, would also have a data file 64 that would contain unique information about the owner of the machine, such as contact information, account information for the purpose of completing payment transactions, and how and when information regarding such details as completed purchasing transactions 67 that would occur automatically and ordinarily by each instance of the apparatus 10 250 260 of the invention owned by said owner. Such data files 64 could be referred to as configuration files, since each one contains specific information that details how the system is to make logical choices 70 when performing automated functions. A further contemplation of the design of the invention would make use of such data files 64 to notify an owner of an apparatus 10 250 260 when a transaction is completed.

One example of such a notification would be the delivery of said transaction data by the automatic release of an email message to one or more email addresses as indicated in the owner's configuration file 64. Since a record of the deposit of the item 50 51 was made at the time of the deposit 67, it would be possible send photographic images of each item 50 deposited along with the transaction data 67. It would also be possible for the message to be broken into a Simple Message Structure (SMS) text message and relay that to personal cell phone 90 or PDA 90. In this manner an operator 100 of a machine could remotely review the detailed data 67 of any given transaction from any individual apparatus 10 250 260 and could thereby make a determination remotely as to the validity of the items 50 51 of the transaction for the purpose of approving the transaction for payment. A payment approval could be made by sending a return SMS message to a specified cellular phone number, and the transaction payment authorization could be completed by the networked computerized programs 70. In another example the owner of the apparatus 10 250 260 could send an email reply to a specific email address that would approve the transaction for payment, and could also include an edited version of the transaction as approved. In another example the owner 100 could log onto the network 80 securely using a common web browser and interact with a set of computer scripts that would allow the owner to review, edit and authorize the transaction payment.

A messaging service is thereby included in the system 150 for the purpose of notifying laypersons 90 100, business entities, and programmable apparatus 10 250 260 of the invention when significant events have occurred. Such events could include the completion of an apparatus 10 250 260 transaction such as purchasing or vending or dispensing a pre-purchased item. Similarly, an event could be the completion of an ACH payment transaction to a layperson selling media 50 51 to an apparatus 10 of the invention, or a receipt sent via SMS or email to a cell phone 90 or PDA 90 for the same transaction.

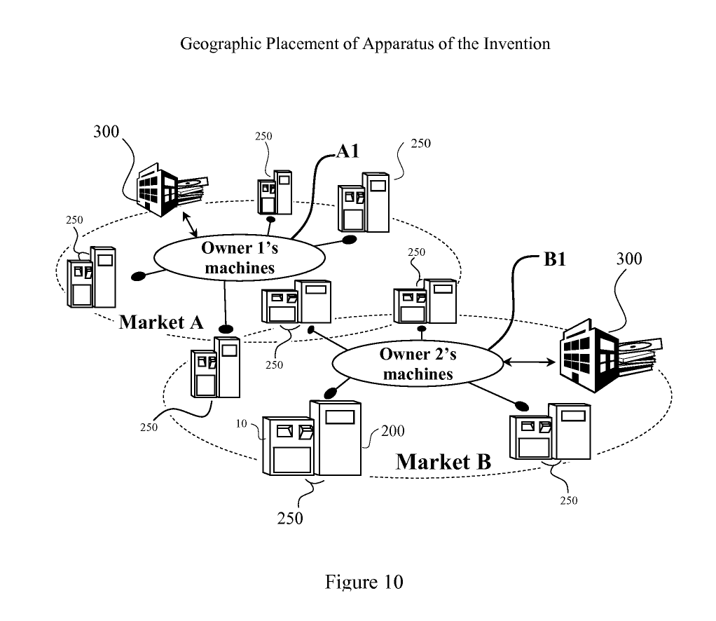

In an enhanced contemplation of the preferred embodiment of the design FIG. 10, the combined 10+200 apparatus 250 with both buying and vending capabilities can be placed in a strategically selected geographical location Market A1. And other units of said enhanced apparatus 250 could also be placed in strategic geographic locations of Market A1, or nearby and proximate Market B1, and the placement of said enhanced apparatus 250 in such strategic locations would, by their adjacent relationships to one another, create a network of units that could function and be used in a coordinated manner. This geographic network of strategically placed, adjacent and contiguous units 250 would be beneficial to a layperson wishing to predetermine which geographic location would be most convenient for selling or purchasing media or other items.

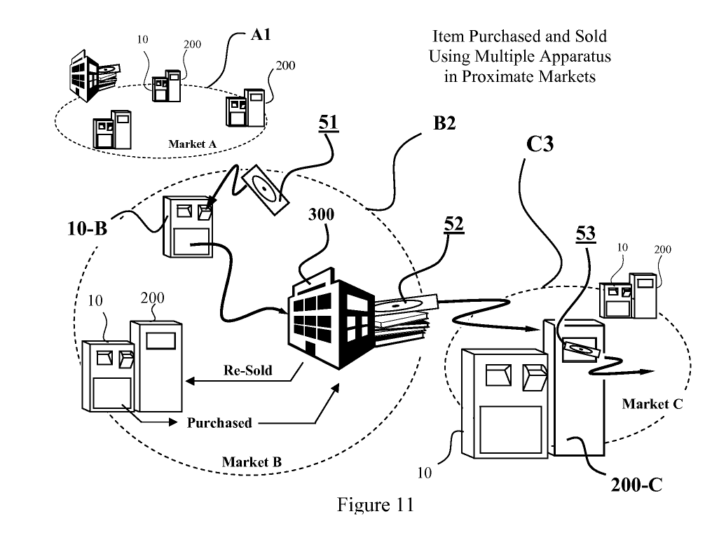

As shown in FIG. 11, these contiguous markets A1, B2 or C3, could be defined by demographic consideration, or by governmental boundaries, or by other similar boundaries. It is also likely that owners and operators of these machines 10 200 250 260 would associate the inventory 300 acquired through random purchases made by said units, and these territorial placements of machines could comprise a virtual market A1 B2 C3 which is defined not by demographic or by governmental boundaries, but by the ownership of the machines 10 200 250 260 and their collective inventory 300, as owned by this single entity of ownership.

Further contemplation of the preferred embodiment of the design, as a network of strategic placements of said units, would allow the network as a system 150 to function as a valuable feature for owners of the machine, and for laypersons who are users of the machines.

In one such example as seen in FIG. 11, a layperson could sell a randomly presented item such as used media 51 to a machine 10-B in Market B, which is the neighborhood and well traveled location of that first layperson. The owner of the machine 10-B who purchases the item 51 from the first layperson would naturally add the purchased item 51 to the owner's inventory 300 and offer it as an item for sale 52. The preferred embodiment of the design of the invention would allow owners of said apparatus of the invention to offer such inventory for sale within their own marketplace B, or in their own vending machines 200, 250. These items for sale could be examined by users 100, and if desired purchased, using common and well known web browsers to access the system 150 which is the method of the invention as shown in FIG. 9. Similarly, a second layperson of a nearby or contiguous Market C could request the item 52 or even purchase the item 52 directly from its current owner in Market B, but retrieve said item 53 from an apparatus of the invention 200-C existing and strategically positioned in Market C.

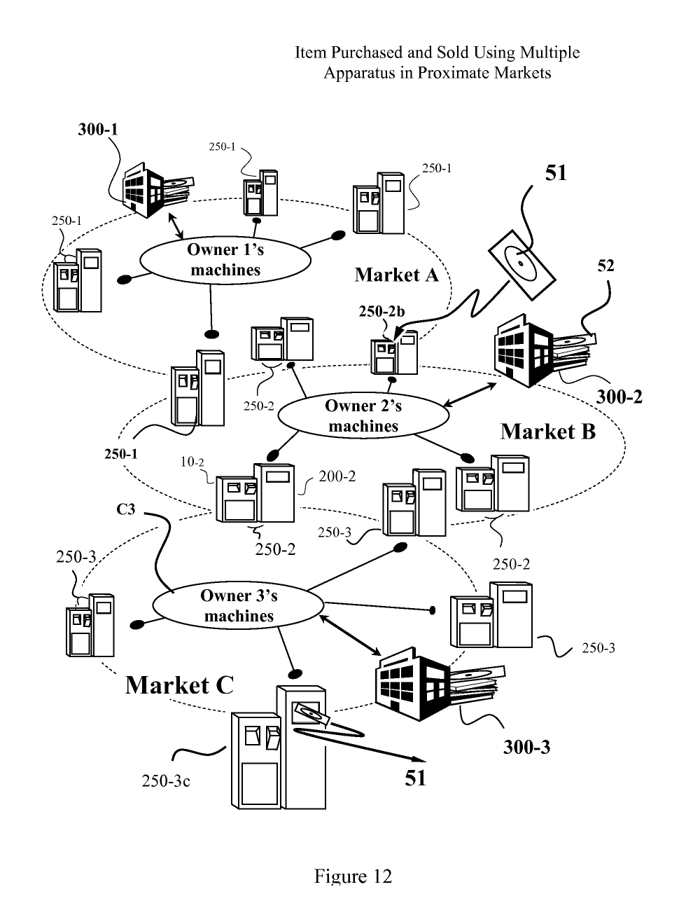

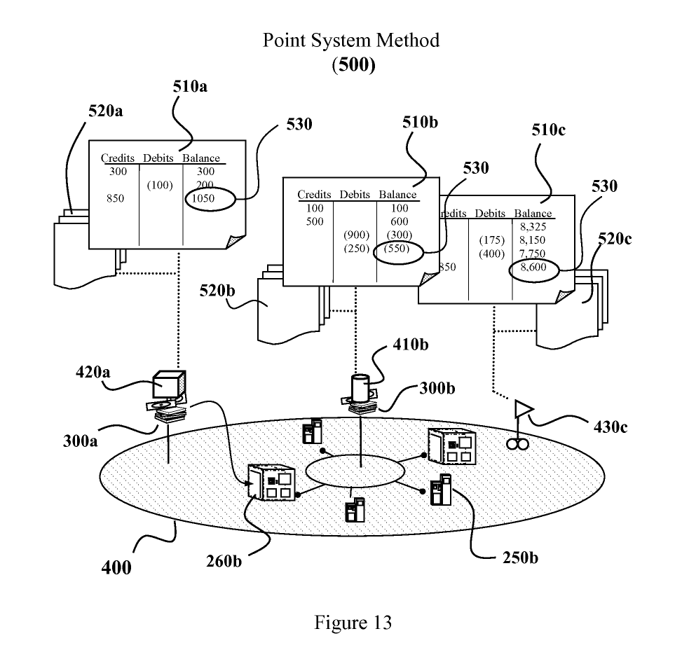

The preferred embodiment of the design could allow such a transaction to occur in a multitude of ways. In one example seen in FIG. 12, wherein the item 51 has been purchased in Market B by Owner 2's apparatus 250-2b and placed into Owner 2's inventory 300-2, the second layperson of Market C could recognize the very same item 52 as being for sale within a Market B that is nearby or adjacent to the neighborhood and well traveled area C of the second layperson, and could make a purchase of the desired and very same item 53 directly from the owner of one instance of the invention 250-3c which is found to be placed conveniently in the local Market C of the second layperson. In this example, the owner of the instance of the invention 250-3 in Market C could directly purchase said item 52 from the owner of the instance of the invention 250-2 in Market B who originally purchased said item 51 from the first layperson. The eventual reseller of the item 53, who owns and operates machines 200, 250 in Market C, could retrieve the item 52 in Market B from Owner 2's machines 250-2b, 250-2, or by another well known method. This new reseller Owner 3 of the item 53 could then deposit it for dispensing into one of the machines 250-3c owned by said reseller in Market C, thus fulfilling the sales transaction as requested by the second layperson, who had specified a machine of the invention 250-3c located in Market C as the preferred and convenient location at the time of her online purchase using the system 150 which is the method of the invention. Alternatively in this example, the first layperson of Market B could sell an item 51 to the owner of the machine 250-2b in Market B, and the second layperson of Market C could purchase the same item 52 for sale in Market C, at a specified location 250-3c which would be convenient to the second layperson, but this sale is made directly by the reseller of Market B who purchased the item 51 directly from the first layperson of Market B. In this alternative condition the reseller of Market B could deposit the item 53 for eventual dispensing directly into the apparatus of the invention 250-3c owned by the reseller Owner 3 of Market C, as specified by the second layperson, using an authorization code which was generated by the networked system 150 that comprises the preferred embodiment of the invention. In this manner, the owner of the apparatus in Market B has purchased directly in Market B 250-2b and also sold directly into Market C by use of the networked apparatus of the invention 250-3c. Wherein the reseller of Market C who has an apparatus 250-3c of Market C as used for vending to the second layperson of Market C is due some consideration for use of said apparatus 250-3c, as requested by the second layperson, a predetermined monetary transaction could be tendered as consideration. Alternatively, a point system of debits and credits as maintained within the system described herein as the preferred embodiment of the invention could be used as a similar means of consideration. An illustrated example of such a point is seen in FIG. 13. In either instance, where such consideration is due because a single transaction has occurred that includes multiple owners of a plurality of apparatus that are used to complete the single transaction, the system contemplated as the preferred embodiment of the invention would automatically notify the parties involved as to the extent of their obligation and also of the consideration as offered for the performance required by parties to the single transaction.

As seen in FIG. 13, parties wishing to participate in such a point system 500 of the broader system 150 would accumulate a series of transaction values as either credits or debits, or both, and could offer parcels of such transaction values to another using a point system. In such a point system 500 wherein the points themselves have a well known value within the system, said points could be used as consideration in any transaction between any parties choosing to participate in the point system 500 which is a method employed within the system 150 which is the method of the invention. For example, and as seen in FIG. 13, an owner 410b of a plurality of apparatus of the invention 250b, 260b operating within a typical geographic or demographic market 400, could purchase, or earn by performance or trade, 100 points and thereby realize a balance of 100 points in the system, and later earn or purchase and additional 500 points, thereby increasing his point balance to 600 points. In a later transaction a value of 900 points could be tendered through trade or performance thus resulting in a balance of (300) or minus three hundred points. And later another 250 points could be tendered as a debit and resulting in a current balance 530 of (550) or minus five hundred and fifty points for business entity 410b, as witnessed in the accounting of 510b 520b of that parties transactions.

Similar participation could be enjoyed by other trading parties in the system such as business entity 420a, having inventory 300a for sale but no ownership of apparatus of the invention 250 260 with which to dispense or purchase items traded in the system of the invention 150. A party such as said business entity 420a could transact with other parties 410b within the system 150 who offer value in trade such as the use of apparatus of the invention 250b 260b for the purpose of vending or dispensing inventory items 300a previously sold within the larger system 150 which is the method of the invention and comprises the system and method 500 allowing points to be used as consideration.

Other parties 430c who have no direct ownership of apparatus of the invention 250b 260b, nor any inventory 300a 300b to offer for sale, could participate within such a system by the performance of services or other valuable acts as contracted by other parties of the system, such as the act of courier when an item located in one geographic location and purchased online by use of the system 150 is specified for eventual dispensing in a distant or proximate market by the layperson making the purchase or by an intermediate party to the transaction.

FIGS. 9 & 14 In another example of the preferred embodiment of the invention, as described herein and consisting of a variety of apparatus 10 250 260 of the invention strategically located across various contiguous and adjacent markets 400, a system of points 500 or other consideration can be offered and administrated by the computerized network 80 and system 150 of said apparatus, and operated in such a fashion as to allow individuals and business entities who are owners or non-owners of said apparatus within any given market to make use of such a network of apparatus for the purpose of selling items of an existing inventory 300 to laypersons of a local market 400 or similarly to laypersons of markets adjacent to their own market 400. The conception of such transactions can occur wholly within the system 150 that operates as the preferred embodiment of the design, or such a transaction could occur in any well known methods for sellers and buyers to transact, such as an existing but separate online marketplace developed and operated for online sales of goods. In any way conceivable, the items presented for sale and finally delivered to the layperson who is the buyer of the items for sale can be placed into the networked system 150 in one location of any given market A, and finally vended out to the layperson making the purchase in any given market B, by means of transaction codes, performance and consideration, as dictated by the system 150 operating as a preferred embodiment of this invention. Further contemplation of the invention allows the practice of couriers 630 who are in the practice of moving items retrieved from an apparatus of the invention placed in one or more local markets and re-depositing them into apparatus of the invention in nearby locations or locations within adjacent markets, to receive consideration in the form of money or points as maintained within the system 150 that is also the preferred embodiment of the invention for said performance.

What is claimed is:

1. A reverse vending machine that can act as a point of deposit for items purchased, which as an assembly includes mechanical and electromechanical components, sensors, and a computerized control system. Additionally, this machine would include a device such as a modem for connecting to a wide area network, and a memory storage which could contain a database of items approved for purchase. Such a machine would be available for public use by laypersons wishing to sell items of various types which could be identified by a common code or description, and therefore priced by referencing the locally stored database. This machine would also provide a method of receiving the items-for-sale and moving said items into an internal storage area. A wide area network connection would allow a summary listing of the items presented for sale to be transmitted to a networked server, and the server would allow connection by a common web browser or similar means for review of the data. An owner of such a machine could then review the contents deposited for sale and approve of those items desired for purchase. Upon approval by the owner, the server would transfer those data as necessary to a well-known electronic banking system which would then transfer a payment from the owner's bank account to that of the seller who deposited the items for sale in the machine.

2. A method of claim 1 wherein the item deposited is flipped during deposit so that both sides may be inspected.

3. A method of claim 1 wherein the item deposited may be recorded upon deposit by camera, rfid reading or similar electronic method.

4. A method of claim 1 wherein the item deposited may be moved laterally and deposited onto a movably elevated platform.

5. A method of claim 1 wherein a second machine can be integrated into the existing solution in such a manner that data can be shared between the two.

6. A method of claim 5 wherein said second machine contains the necessary mechanical, electromechanical, and electronic components to vend or dispense the same types of products that the machine of claim 1 is used to purchase.

7. A method of claim 1 or of claim 5 wherein the computerized control system uses a touchscreen to allow persons to input or receive information as data.

8. A method of claim 1 or claim 5 wherein the computerized control system would transfer critical data such as items purchased to be transferred through a wide area network to a central file server, where such data could remain until further processing is needed.

9. A method of claims 1, 6, 7 and 8 wherein critical data that originates at either the machine of claim 1 or the machine of claim 5, or on the server of claim 8 can be accessed by the owner of said machines by use of a common web browser connected to the server of claims 1 and 8 so as to allow review of said data, editing of said data, or the presentation of new data items such as items existing as inventory for sale, or special database entries such as pricing schedules for items approved for purchase or other items not allowed for purchase, or similar data which represent common attributes for items purchased, or items vended.

10. A method of item 1 wherein the items presented to the machine by the general public who would be ordinary users of said machine may be well known and commonly valued items such as printed or electronic media as commonly owned by a wide membership of the local community, such as books, music CDs, movies stored on tape or disks formatted as VHS, DVD, Blue Ray, or other commonly used formats, or specialty items of similar media, or similarly well known and valuable electronic items such as cell phones, music players, PDAs, and more, or other commonly owned and valuable items such as watches or jewelry, or sporting equipment or gaming devices and equipment, or any commonly owned and valuable item that may be valued by means of a predetermined or determinable price.

11. A method of claim 1 and claim 10 wherein any member of the public as layperson may present an item of the type purchased by said machine as described in claim 1 by exposing a bar code symbol to a bar code reader, or by entering a description as described in claim 7, and may receive an offer to purchase from said machine by the method of claim 7, and may elect to deposit said item into said machine as described by the method of claims 1 and 4, with said item being deposited and offered as consideration to the owner or operator of said machine.

12. A method of claim 1 and claim 11 wherein the item being presented by a layperson as consideration in a sale may be valued by searching a series of database tables stored locally in the permanent memory of the machine of claim 1 or 5, or stored on the server of claim 1 and claim 9, or stored on other servers that may be accessed through the wide area network, and returning a data element of said data tables, said element representing a price for said item as a tentative offer to purchase.

13. A method of claims 1, 8, 9, 11 and 12 wherein the item deposited for sale as described in claim 11 and valued and priced as in claim 12 may be physically removed and examined as in claim 1 reviewed as and offer to buy as in claim 9 by the owner of said machine, and the transaction which originated as a tentative offer to purchase may be finalized and approved for payment as described in claim 9.

14. A method of claim 6 wherein a layperson may purchase vendible items remotely by use of a common web browser which would make connection to the server of claim 8 through a wide area network, allowing such data as items purchased, the name of the purchaser, and a special serial transaction number which would be unique to said purchase to be transferred to said machine of claim 5.

15. A method of claim 1 or claim 5 wherein the computerized control system would receive critical data from a central file server, as the reverse operation of claim 8, allowing such data as items purchased and special unique serial number for such items, as described in claim 10.

16. A method of claim 6 wherein a purchaser of items as in claim 9 may identify items purchased by entering the transaction serial number received with the web browser transaction of claim 14 onto a touchscreen computer of claim 7 which could be the computerized control system of the machine of claim 1 or a similar computerized controller of the machine of claim 5.

17. A method of claim 6 wherein a purchase as described in claim 14 is vended to the purchaser identified through the methods described in claim 12.

18. A method of claims 6 and 17 wherein the owner of said machine and of said inventory vended is paid for said items purchased through a series of data transactions on the server as described in claims 1, 15 and 17.

19. A method as described in claims 1, 6, 14 and 17 wherein an item or items as inventory owned by an owner of a machine of claim 1 or of claim 5 may be selected and purchased by a layperson using a common web browser, and said purchaser of said inventory may specify, as a condition of the sale, one of several machines owned by said owner, in such a manner that the item is vended through one of said machines based on a geographical location that is desirable to the purchaser.

20. A method of claim 1, claim 5 and claim 9 wherein an owner of inventory as vended by the machine of claim 5 that is not an owner of said machine of claim 1 or of claim 5 can offer inventory for sale by the method of claim 9, and said owner of inventory may physically place into said machine said items being sold by such methods as claim 14 or claim 19 after such a purchase has been made.

21. A method of claim 16 and claim 18 wherein the proceeds of said sold items are automatically paid as partial payments made to both the owner of the machine of claim 1 or claim 5, and the owner of the inventory who is not the owner of said machines, as described in claim 20, by a predetermined and calculated percentage as may be specified in the data stored on the server of claim 9.

22. A method of claim 1 and claim 9 wherein a buyer of items as may be purchased by said machine of claim 1 who is not the owner of said machine may offer to purchase items directly from a layperson presenting items for sale to said machine by use of a purchasing data table as described by the method of claim 12, wherein the item being presented may be identified as an item primarily purchased by the non-owner of said machine. Inspection of said item purchased, and approval for payment of said item may be made by the non-owner of said machine through physical inspection by the non-owner after removal of said item from said machine, and by approving and finalizing the transaction as described in claim 13.

23. A method of claim 22 wherein a specialized serial number similarly described in claim 16 is assigned to the item presented in claim 22, and the non-owner of the machine as described in claim 22 is the recipient of the specialized serial number created for such a transaction as described in claim 22, and the non-owner may physically remove an item presented for sale as described in claim 22, wherein the issue of said specialized serial number to the non-owner of claim 22 who is also the primary purchaser of said item is used an authorization to become the physical owner of the item being purchased, and therefore a transfer of ownership from the layperson presenting the item for purchase is made directly to the non-owner of said machine by ordinary use of said machine.

24. A method of claims 1 and 6, and of claims 20 and 22, wherein a plurality of machines are owned and operated by multiple parties, and said machines are connected to a central server or servers by means of wide area network, and said machines are available to owners and non-owners of said machines for purchasing items and vending purchased items or other inventory, each using their own machines or the machines of other owners, or using the machines as non-owners, and the existence of said plurality of said machines throughout a geographical market thereby comprise a network of well-known locations of machines that can be used by laypersons desiring to sell or purchase such items as are purchased or vended by said machines.

25. A method of claim 19 and claim 24 wherein the location of the owner of said item for vending is a geographic market which is proximate to and geographically adjacent to the location desired for pickup by a layperson making a purchase as described in claim 14, and a third party acting as employee of the seller of inventory, or acting as the employee of the buyer, or acting as an independent contractor as courier, may be issued a specialized serial number which allows for the removal of said item being purchased from a machine located in the vicinity of the seller, and then by further use of said serial number, also allows the deposit of said item into a machine at the location originally specified by said buyer of said item as specified at the time of purchase of said item by said buyer.

26. A method of claim 25 wherein an ordinary transaction between a layperson desiring to purchase an item as described in claim 14 and a seller of inventory using a machine as non-owner, and said item purchased requiring transport from one geographical area near the seller of the inventory to a location specified, is completed as a total transaction involving a number of parties such as seller of said item as non-owner of a machine, the owner of said machine used for deposit of item sold, and one or more independent contractors acting as courier between locations, and the total price including the involvement of said multiple parties to the sale is automatically calculated by the server to which the purchasing layperson's browser is connected, and is presented as a single price to the layperson, and the price thereby paid as consideration and as a sum of individual costs is automatically distributed to each party to the sale by the server or servers hosting the transaction and by such well-known banking services as indicated in claim 1, and each party earning payment is paid according to the calculated percentage of the total sum presented to the layperson making said purchase.

27. A method of claims 24, 25 and 26 wherein ordinary transactions are occurring across a network of machines comprising a geographical market, and such transactions are continually involving a large number of parties to various transactions as machine owners who are also operators as buyers and sellers, and now-owners who are buying and selling through said network of machines as owned by others, and couriers who are actively moving items bought and sold throughout the system, and such ordinary transactions are occurring within a specialized system as a network of well-known locations of machines, and such a specialized system is so commonly used by all parties, that a specialized point system may be used as consideration by those parties desiring to participate in said point system.

28. A method of claim 27 wherein points that are commonly used as consideration may be valued according to demand and usage, and thereby traded for currency of any ordinary denomination, or similarly purchased by exchange of currency.

29. A method of claims 1, 3, 8 and 9 wherein the item deposited for sale by a layperson has been recorded as a digital image by camera or similar method and the image captured is then transferred by wide area network to the server or servers described in method 8 and upon receipt by said server is further transported by wide area network to a PDA or personal computer or hand held device that is capable of rendering such an image for display, as desired and requested by the owner or operator or non-owner as occasional user of said machine of item deposit, and such an image or series of images is examined by the recipient as a means of remotely viewing and thereby approving for purchase said item as deposited for sale and as recorded.
